(19) United States
(12) Patent Application Publication
(10) Pub. No.: US 2012/0030587 A1
(43) Pub. Date: Feb. 2, 2012

(54) SYSTEMS AND METHODS FOR SHARING MEDIA USING SOCIAL MEDIA GUIDANCE APPLICATIONS

(76) Inventor: Neel Ketkar, Santa Monica, CA (US)

(21) Appl. No.: 12/848,028

(22) Filed: Jul. 30, 2010

(51) Int. Cl. G06F 3/01; G06F 15/16

(52) U.S. Cl. 715/751

(57) ABSTRACT

Systems and methods for social media guidance applications are provided. A social media guidance application may be integrated with one or more social networks associated with a user. In some embodiments, the application may receive input from a user to publish a media recommendation to the user's social network profile. The application may locate media to include in the media recommendation, and publish the media recommendation to the user's profile. The application may locate media within a social media content source accessible from a user equipment device. The application may prompt the user for comments and ratings before sending the media recommendation.

### BACKGROUND OF THE INVENTION

The invention relates generally to media systems, and more particularly, to integrating media guidance systems and social networks.

An interactive media guidance application allows a user to navigate and access media content accessible by user equipment. The accessible media content may include digital broadcast television channels, interactive applications, digital music, on-demand programming, Internet resources, and recorded content.

Social network services focus on building social networks or social relations among people, e.g., who share interests or activities. Popular social networking services include Facebook™, MySpace™, and Twitter™.

### SUMMARY OF THE INVENTION

The invention provides seamless integration of social networks, such as Facebook™ and Twitter™, within interactive media guidance applications. Such an integrated user experience is referred to herein as a “social media guidance application”. Although this term implies that a single application provides integrated social networking and media guidance functionality, in some embodiments, the integrated experience may be provided via multiple applications.

A social media guidance application may be in communication with one or more social networks associated with a user. In some embodiments, the social media guidance application may receive input from a user to publish a media recommendation to the user's social network profile. A media recommendation may include media, comments, or ratings, for any type of media asset, for example, network shows or programs, video or audio clips, web pages, electronic books, and other types of media assets. The social media guidance application may locate media to include in the media recommendation, and publish the media recommendation to the user's profile. The social media guidance application may prompt the user for comments and ratings before sending the media recommendation.

The social media guidance application may locate media within a social media content source, e.g., a video library on a local or remote server, accessible from a user equipment device. The social media content source may include cable sources, satellite providers, on-demand providers, Internet providers, local or remote media servers, or other providers of media content. The social media guidance application may invoke a media locator on the user equipment device to search for related media in the social media content source. For network shows or programs, the social media guidance application may use guide information to search the social media content source. For example, the social media guidance application may obtain the program name, channel, and airtime, from guide information to aid in the search for related media. In some embodiments, the social media guidance application may extract media from a recording on the user equipment device, and include the extracted media in the media recommendation. For example, if an episode or clip of a program being recommended by the user is previously stored or being currently recorded on the user equipment device (e.g., a digital video recorder), the social media guidance application may extract a clip or include the recording itself in the media recommendation. Before inclusion in the media recommendation, the social media guidance application may convert the located media to a format playable on the target user equipment device. For example, if the target user equipment device includes a personal computer (PC), the social media guidance application may convert the media to a PC-friendly format, e.g., MPEG-4.

In some embodiments, the social media guidance application may receive a media recommendation for the user from the social network. The media recommendation may include comments and ratings. If the media recommendation includes media, the social media guidance application may convert media to a format playable on the user equipment device. In some embodiments, the social media guidance application may substitute media received with the media recommendation with media it locates itself. For example, if the media recommendation includes a clip of a program, the social media guidance application may replace it with the full program episode associated with the received clip. The social media guidance application may locate media within a social media content source, e.g., a collection of media on the user equipment device or on a remote server. The social media content source may provide media such as audio and video clips, program episodes, advertisements, blooper reels, cast interviews, promotional trailers, and online links to any of the above types of media. The social media guidance application may invoke a media locator to search for related media in the social media content source. The social media guidance application may use guide information received with the media recommendation to search the social media content source. In some embodiments, the social media guidance application may suppress duplicate media recommendations received in the past.

In some embodiments, a social media guidance application may automatically publish media recommendations to a user's social network profile or send media recommendations to other users of the social network, based on the user's viewing activity. The social media guidance application may invoke a media locator to search for related media in a social media content source. The social media guidance application may automatically identify media to include in the media recommendation, and may prompt the user for comments and ratings for the program.

In some embodiments, a system for supporting a social media guidance application implemented at least partially on user equipment may include a user input interface, a display device and control circuitry configured to execute the steps as described above.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative media system for a social media guidance application;

FIG. 2 shows an illustrative user equipment device in accordance with an embodiment of the invention;

FIG. 3 is a simplified diagram of an illustrative interactive media system in accordance with an embodiment of the invention;

FIG. 4 shows an illustrative display screen that may be used to provide media guidance application listings in accordance with an embodiment of the invention;

FIG. 5 shows an illustrative display screen with menu options for a social media guidance application in accordance with an embodiment of the invention;

FIG. 6 shows an illustrative automatic sharing preferences screen for a social media guidance application in accordance with an embodiment of the invention;

FIG. 7 shows an illustrative login prompt for a social media guidance application in accordance with an embodiment of the invention;

FIG. 8 shows an illustrative send program recommendation prompt for a social media guidance application in accordance with an embodiment of the invention;

FIG. 9 shows an illustrative receive friend recommendation prompt for a social media guidance application in accordance with an embodiment of the invention;

FIG. 10 shows an illustrative receive program recommendation prompt for a social media guidance application in accordance with an embodiment of the invention;

FIG. 11 shows an illustrative receive program recommendation prompt for a social media guidance application in accordance with another embodiment of the invention;

FIG. 12 shows an illustrative receive program recommendation prompt for a social media guidance application in accordance with yet another embodiment of the invention;

FIG. 13 shows an illustrative flow diagram for transmitting recommendations via a social media guidance application in accordance with an embodiment of the invention;

FIG. 14 shows illustrative flow diagram for receiving recommendations via a social media guidance application in accordance with an embodiment of the invention; and

FIG. 15 shows an illustrative flow diagram for identifying media to present as part of a program recommendation in accordance with an embodiment of the invention.

### DETAILED DESCRIPTION OF EMBODIMENTS

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications run on one or more of user equipment devices and allow users to navigate among and locate content related to the video content including, for example, video clips, articles, advertisements, chat sessions, games, etc. Guidance applications also allow users to navigate among and locate multimedia content. The term multimedia is defined herein as media and content that utilizes at least two different content forms, such as text, audio, still images, animation, video, and interactivity content forms. Multimedia content may be recorded and played, displayed or accessed by information content processing devices, such as computerized and electronic devices, but can also be part of a live performance. It should be understood that the invention embodiments that are discussed in relation to media content are also applicable to other types of content, such as video, audio and/or multimedia.

With the growing popularity of social networks, such as Facebook™, MySpace™, and Twitter™, users have limitless potential to share ideas, activities, events, and interests. A social network service essentially consists of a representation of each user (e.g., a profile), his social links, and a variety of additional services. In accordance with the disclosed embodiment, an interactive media guide experience may be integrated with a social media guidance application. Such a social media guidance application may provide seamless integration of social networks with interactive media guidance applications. A user may communicate with the social media guidance application through a user equipment device. The user of the social media guidance application may post media recommendations to his social network profile, or send and receive media recommendations through his social network. A media recommendation may include media, comments, or ratings, for any type of media asset, for example, network shows or programs, video or audio clips, web pages, electronic books, and other types of media assets. In addition, the social media guidance application may aid the user in searching for related media to include with the media recommendation. Though the following embodiments may refer to a program recommendation, an example of a media recommendation, the invention is not limited to recommendations for programs only. A media recommendation may be for any type of media asset, as disclosed above.

In some embodiments, the social media guidance application may automatically identify the most appropriate media, or offer the user an array of media to choose from. For example, if a user is a fan of the program “Lost” on the ABC™ channel, he may post positive comments or reviews of the program. If the user wants to include a clip of the program, the social media guidance application may aid the user by searching one or more content sources, e.g., a social media content source, and offering an array of media to choose from. A social media content source may include cable sources, satellite providers, on-demand providers, Internet providers, local or remote media servers, or other providers of media content. The social media content source may provide media such as audio and video clips, program episodes, advertisements, blooper reels, cast interviews, promotional trailers, and online links to any of the above types of media. The user recommendation may be posted with a link to the user-specified media. The recommendation may be further adapted to be accessible by other social networking applications, e.g., applications on different platforms. For example, the media included with the recommendation may be converted to a format compatible with the target platform. In some embodiments, the application may include a media locator that searches a social media content source for related media that is accessible via the social network. The located media may include a link to media on the Internet, exclusive media offered to users of the social media guidance application such as interviews and blooper reels, a clip extracted from a recording of the program on the user equipment device, or metadata markers to local and remote media accessible to the user.

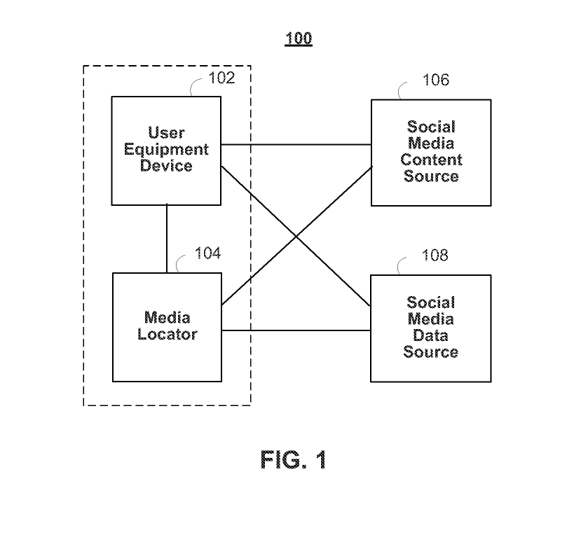

FIG. 1 shows illustrative media system 100 for a social media guidance application. User equipment device 102 may include user television equipment, user computer equipment, wireless user communications device, or any other type of user equipment suitable for accessing media, such as a non-portable gaming machine. User equipment devices, on which a social media guidance application is implemented, may function as a standalone device or may be part of a network of devices.

In some embodiments, the social media guidance application may be implemented as widget on the user equipment device. The widget may form the interface between a social network and a media guidance application. Widgets are software programs that provide information from the Internet to a user through web services, and run on a user equipment device. For example, widgets may provide meaningful data and/or other interactive features to a user related to media that the user is interested in.

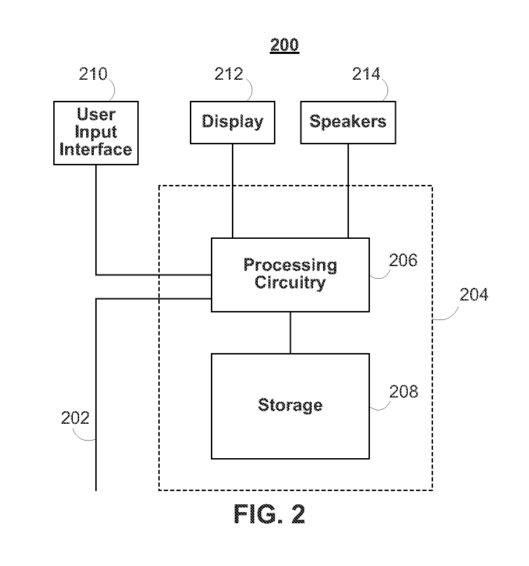

The widget may be an application that is downloaded or installed on user equipment device 104, and may be run by an interpreter or virtual machine (run by the control circuitry of user equipment device 104, e.g., control circuitry 204 in FIG. 2). The widget may allow the user to interact with web services while viewing media on user equipment device 104. The widget may have the same layout on the various types of user equipment devices or may be tailored to the display capabilities of the user equipment device. For example, on user equipment device 104, the widget may run as a persistent (e.g., always-running) application. In another example, the widget may be scaled down for a wireless user communications device.

In some embodiments, the social media guidance application may be encoded in the ETV Binary Interchange Format (EBIF), received by control circuitry 204 (FIG. 2) as part of a suitable feed, and interpreted by a user agent running on control circuitry 204 (FIG. 2). For example, the widget may be a EBIF widget and user equipment device 104 may be a set-top box. In other embodiments, the widget may be defined by a series of JAVA-based files that are received and run by a local virtual machine or other suitable middleware executed by control circuitry 204 (FIG. 2). In some of such embodiments (e.g., those employing MPEG-2 or other digital media encoding schemes), the guidance application may be, for example, encoded and transmitted in an MPEG-2 object carousel with the MPEG audio and video packets of a program. In the example, the widget may be an OCAP widget (e.g., a tru2way widget), and user equipment device 104 may be a set-top box.

User equipment device 104 may be in communication with one or more social networks via social media content source 106 and social media data source 108. Social media content source 106 may provide a searchable database of media accessible via the social network. Social media data source 108 may provide information on user viewing habits and program recommendations, which may be useful for certain features, e.g., automatic program recommendations. Sources 106 and 108 may include cable sources, satellite providers, on-demand providers, Internet providers, local or remote media servers, or other providers of media content. In some embodiments, social media content source 106 provides media such as audio and video clips, program episodes, advertisements, blooper reels, cast interviews, promotional trailers, and online links to any of the above types of media. In some embodiments, social media data source 108 includes user profile data for one or more social networks. User profile data may include a list of programs that the user watches on regular basis, friends of the user in the social network, the user's demographic information, and other related user profile data. Social media data source 108 may further include metadata sets that capture data from user recommendations, e.g., program name, media, time of recommendation, recommendation sender/receiver, and other related information included in a user recommendation. For example, social media data source 108 may include a community metadata sets that stores data from all users in the social network. A community metadata set may be visible or accessible to all or most users in the user's social network. Social media data source 108 may also include private metadata sets limited to one or more users. A private metadata set may be visible or accessible to only the user's friends in the social network, limited to other users specified by the user, or accessible to the user only.

When a user wishes to make a program recommendation, a social media guidance application may be triggered on user equipment device 102. The application may present the user with a prompt to input comments and ratings on the program. In some embodiments, the user may specify media to attach to the recommendation. The media may be present locally on the user equipment device (e.g., a previously recorded program or a program currently being recorded on a personal digital video recorder (DVR)), or may be located on a remote server or website, e.g., Youtube™ or Hulu™. In some embodiments, the user may be given an array of media to choose from. The media may include video clips, audio clips, program episodes, program screenshots, online links, and other related media. The application may invoke media locator 104 to produce the list of media to present to the user. In some embodiments, media locator 104 may be a part of the social media guidance application. Media locator 104 may be resident in user equipment device 102, a remote server, or partially stored on both. For example, media locator 104 may include a client program on the user equipment device for processing information, and a server program running on a remote server for converting file formats. Media locator 104 may search in social media content source 106, where media may be tagged with information from previous recommendations, as well as data from social media data source 108. For example, a media clip previously included in a user program recommendation may be tagged with the user's comments and ratings. If the media clip has been recommended by other users (based on data from, e.g., social media data source 108), the media clip may be further tagged with other users' comments and ratings. In some embodiments, the network service provides a link to attach with the recommendation. For example, when a user recommends the program “Lost” on the ABC™ network, media locator 104 may provide a episode link associated with ABC™ at their website, abc.com.

In some embodiments, the application may choose from the array automatically without user intervention. In some embodiments, the media may be identified based on user-specified criteria, such as clip length or quality. For example, the application may choose a full episode over a clip, or HD version over the non-HD version. For example, the application may make a choice based on input from the community metadata set of social media data source 108. The community metadata set may suggest media popularity, e.g., if the clip has been recommended by other users in the social network. The media may be obtained from social media content source 106. In some embodiments, source 106 and 108 may include a single social media source.

The social media guidance application may also be triggered on user equipment device 102 when the user receives a program recommendation. In embodiments where the recommendation includes media, the application invokes media locator 104 to validate the attached media. For example, media locator 104 may replace a program clip with the entire episode during validation. Upon receiving the media, media locator 104 may identify the program associated with the media, and then attempt to locate substitute media. For example, media locator 104 may locate a full episode related to a received program clip, or locate a HD version of received non-HD media. The episode may be a link to a streaming video website, or a local recording available on the user equipment device. If the attached media is a file, media locator 104 may validate the attached media by converting the file to a format playable on the user equipment device. For example, if the recommendation is received on a mobile device, the file may be converted to a format appropriate for playback on a mobile device. Alternatively, media locator 104 may find a link to a compatible file that may have been converted in the past. If the attached media is a link or metadata, media locator 104 may check the their validity. For example, media locator 104 may determine that a link received from the social network to be broken. In such a case, it may search for related media in social media source 106 based on data from the program recommendation.

In embodiments where the media is not included in the recommendation, or if the attached media is missing or corrupted, media locator 104 may search in social media content source 106 for media to match the recommendation. The media search may be based on tags generated from previous recommendations, or data from social media data source 108. For example, a media clip previously included in a user program recommendation may be tagged with the user's comments and ratings. If the media clip has been recommended by other users (based on data from social media data source 108), the media clip may be further tagged with other users' comments and ratings.

In some embodiments, the attached media may include metadata for indexing in to a local copy of a program on the user equipment device. For example, after a user makes a program recommendation, the social media guidance application may update the community metadata set with recommendation data, and learn from the community metadata set that both users record “The Simpsons”. When the user makes a recommendation for “The Simpsons” to another user and includes a clip from an episode recorded on his user equipment device, the social media guidance application may only send metadata pointers for the clip. Since the other user's equipment device also contains a recording of the episode, media locator 104 may locate the clip by extracting it from the local recording based on the attached metadata. The decision to send metadata instead of the clip may be based on the type of cable subscription of the target user. For example, the social media guidance application may send metadata only if both users subscribe to a similar tier of service. The social media guidance application may receive user information, e.g., the user's tier of service, from the service provider.

Users may access social media content or data and the social media guidance application (and its display screens described above and below) from one or more of their user equipment devices. A generalized embodiment of an illustrative user equipment device for use in a media system (e.g., user equipment device 102 in media system 100 of FIG. 1) is shown in FIG. 2. User equipment device 200 may receive media content and data via input/output (hereinafter “I/O”) path 202. I/O path 202 may provide media content (e.g., broadcast programming, on-demand programming, Internet content, and other video or audio) and data to control circuitry 204, which includes processing circuitry 206 and storage 208. Control circuitry 204 may be used to send and receive commands, requests, and other suitable data using I/O path 202. I/O path 202 may connect control circuitry 204 (and specifically processing circuitry 206) to one or more communications paths (described below). I/O functions may be provided by one or more of these communications paths, but are shown as a single path in FIG. 2 to avoid overcomplicating the drawing.

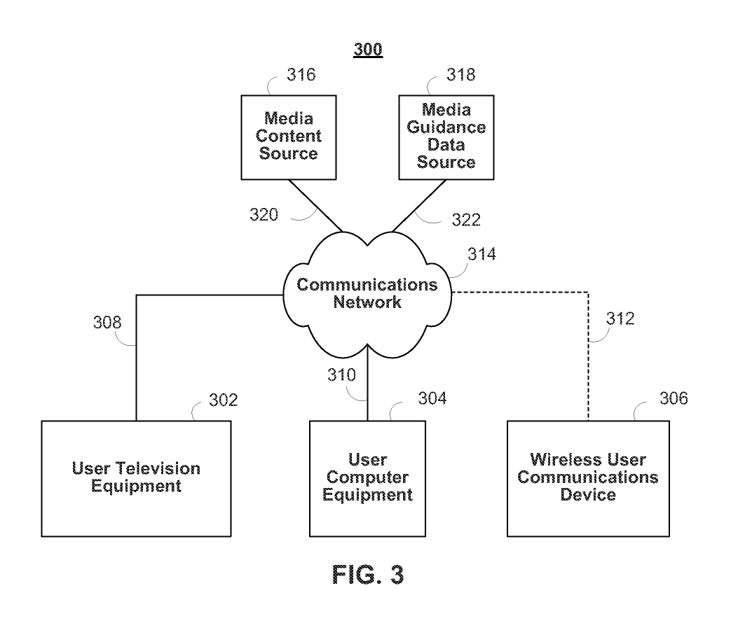

Control circuitry 204 may be based on any suitable processing circuitry 206 such as processing circuitry based on one or more microprocessors, microcontrollers, digital signal processors, programmable logic devices, etc. In some embodiments, control circuitry 204 executes instructions for a media guidance application stored in memory (i.e., storage 208). In client-server based embodiments, control circuitry 204 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 3). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 208 that is part of control circuitry 204. Storage 208 may include one or more of the above types of storage devices. For example, user equipment device 200 may include a hard drive for a DVR (sometimes called a personal video recorder, or PVR) and a DVD recorder as a secondary storage device. Storage 208 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 204 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 204 may also include scaler circuitry for upconverting and downconverting media into the preferred output format of the user equipment 200. Circuitry 204 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 208 is provided as a separate device from user equipment 200, the tuning and encoding circuitry (including multiple tuners) may be associated with storage 208.

A user may control the control circuitry 204 using user input interface 210. User input interface 210 may be any suitable user interface, such as a remote control, mouse, trackball, keypad, keyboard, touch screen, touch pad, stylus input, joystick, voice recognition interface, or other user input interfaces. Display 212 may be provided as a stand-alone device or integrated with other elements of user equipment device 200. Display 212 may be one or more of a monitor, a television, a liquid crystal display (LCD) for a mobile device, or any other suitable equipment for displaying visual images. In some embodiments, display 212 may be HDTV-capable. Speakers 214 may be provided as integrated with other elements of user equipment device 200 or may be stand-alone units. The audio component of videos and other media content displayed on display 212 may be played through speakers 214. In some embodiments, the audio may be distributed to a receiver (not shown), which processes and outputs the audio via speakers 214.

A user equipment device (e.g., user equipment device 200 of FIG. 2) may be implemented in illustrative system 300 of FIG. 3 as user television equipment 302, user computer equipment 304, wireless user communications device 306, or any other type of media device suitable for accessing media, such as a non-portable gaming machine. For simplicity, these devices may be referred to herein collectively as media devices. A media device, on which media content is presented, may function as a standalone device or may be part of a network of devices. Various network configurations of devices may be implemented and are discussed in more detail below.

User television equipment 302 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 304 may include a PC, a laptop, a tablet, a WebTV box, a personal computer television (PC/TV), a PC media server, a PC media center, or other user computer equipment. WEBTV is a trademark owned by Microsoft Corp. Wireless user communications device 306 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 302, user computer equipment 304, and wireless user communications device 306 may utilize at least some of the system features described above in connection with FIG. 2 and, as a result, include flexibility with respect to the type of media content available on the device. For example, user television equipment 302 may be Internet-enabled allowing for access to Internet content, while user computer equipment 304 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 300, there is typically more than one of each type of user equipment device but only one of each is shown in FIG. 3 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 314. Namely, user television equipment 302, user computer equipment 304, and wireless user communications device 306 are coupled to communications network 314 via communications paths 308, 310, and 312, respectively. Communications network 314 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 308, 310, and 312 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 312 is drawn with dotted lines to indicate that in the exemplary embodiment shown in FIG. 3 it is a wireless path and paths 308 and 310 are drawn as solid lines to indicate they are wired paths (although these paths may be wireless paths, if desired). Communications with the user equipment devices may be provided by one or more of these communications paths, but are shown as a single path in FIG. 3 to avoid overcomplicating the drawing.

Although communications paths are not drawn between user equipment devices, these devices may communicate directly with each other via communication paths, such as those described above in connection with paths 308, 310, and 312, as well other short-range point-to-point communication paths, such as USB cables, IEEE 1394 cables, wireless paths (e.g., Bluetooth, Infrared, IEEE 802.11x, etc.), or other short-range communication via wired or wireless paths. BLUETOOTH is a certification mark owned by Bluetooth SIG, INC. The user equipment devices may also communicate with each other directly through an indirect path via communications network 314.

System 300 includes media content source 316 and media guidance data source 318 coupled to communications network 314 via communication paths 320 and 322, respectively. Paths 320 and 322 may include any of the communication paths described above in connection with paths 308, 310, and 312. Communications with the media content source 316 and media guidance data source 318 may be exchanged over one or more communications paths, but are shown as a single path in FIG. 3 to avoid overcomplicating the drawing. In addition, there may be more than one of each of media content source 316 (e.g., social media content source 106 in FIG. 1) and media guidance data source 318 (e.g., a social media data source 108 in FIG. 1), but only one of each is shown in FIG. 3 to avoid overcomplicating the drawing. (The different types of each of these sources are discussed below.) If desired, media content source 316 and media guidance data source 118 may be integrated as one source device. Although communications between sources 316 and 318 with user equipment devices 302, 304, and 306 are shown as through communications network 33, in some embodiments, sources 316 and 318 may communicate directly with user equipment devices 302, 304, and 306 via communication paths (not shown) such as those described above in connection with paths 308, 310, and 312.

Media content source 316 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 316 may be the originator of media content (e.g., a television broadcaster, a Webcast provider, etc.) or may not be the originator of media content (e.g., an on-demand media content provider, an Internet provider of video content of broadcast programs for downloading, etc.). Media content source 316 may include cable sources, satellite providers, on-demand providers, Internet providers, or other providers of media content. Media content source 316 may also include a remote media server used to store different types of media content (including video content selected by a user), in a location remote from any of the user equipment devices. Additionally, media guidance content source 316 may include media tagged with social network information to form a social media content source (e.g., social media content source 106 in FIG. 1). For example, media may be tagged with ratings from users in a social network. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 318 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections. Additionally, media guidance data source 318 may include social network information to form a social media data source (e.g., social media data source 108 in FIG. 1). The social network information may include, e.g., users in a social network, and other information in the media guidance data source may be linked to the social network information.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 318 may be provided to users' equipment using a client-server approach. For example, a guidance application client residing on the user's equipment may initiate sessions with source 318 to obtain guidance data when needed. Media guidance data source 318 may provide user equipment devices 302, 304, and 306 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 204 of user equipment device 200 and partially on a remote server as a server application (e.g., media guidance data source 318). In some embodiments, integrated social networking and media guidance functionality may be provided via multiple separate applications. In some embodiments, the social media guidance application may include a social networking application in communication with a media guidance application. The social media guidance application may run as a stand-alone application that communicates with a media guidance application and a social networking application. The social media guidance application may communicate with the interactive media guidance application and the social networking application via one or more Application Programming Interface (APIs).

In some embodiments, the social media guidance application may be implemented as a widget. The widget may run on the user equipment device, and connect to remote servers, e.g., social media data source 108 (FIG. 1) and social media content source 106 (FIG. 1). The widget may form the interface between a social network and a media guidance application. For example, the widget may use web services to provide a user interface to the user. The user interface displays may be generated by the social media guidance data source and transmitted to the user equipment device. The social media guidance data source may also transmit data for storage on the user equipment, which then generates the user interface displays based on instructions processed by control circuitry.

Media guidance system 300 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 3.

In one approach, user equipment devices may communicate with each other within a home network. User equipment devices can communicate with each other directly via short-range point-to-point communication schemes describe above, via indirect paths through a hub or other similar device provided on a home network, or via communications network 314. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 316 to access media content. Specifically, within a home, users of user television equipment 304 and user computer equipment 306 may access the media guidance application to navigate among and locate desirable media content. Users may also access the media guidance application outside of the home using wireless user communications devices 306 to navigate among and locate desirable media content.

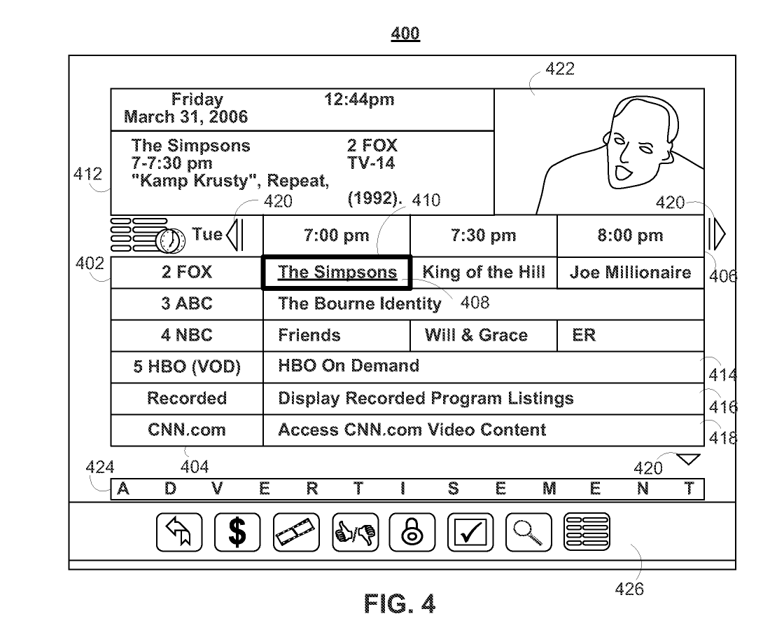

One of the functions of the media guidance application is to provide media listings and media information to users. FIG. 4 shows an illustrative display screen that may be used to provide media guidance, and in particular media listings. The display screens may be implemented on any suitable device or platform. While the displays are illustrated as full screen displays, they may also be fully or partially overlaid over media content being displayed.

A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 4 shows illustrative grid program listings display 400 arranged by time and channel that also enables access to different types of media content in a single display. Display 400 may include grid 402 with: (1) a column of channel/media type identifiers 404, where each channel/media type identifier (which is a cell in the column) identifies a different channel or media type available; and (2) a row of time identifiers 406, where each time identifier (which is a cell in the row) identifies a time block of programming. Grid 402 also includes cells of program listings, such as program listing 408, where each listing provides the title of the program provided on the listing's associated channel and time. With a user input device, a user can select program listings by moving highlight region 410. Information relating to the program listing selected by highlight region 410 may be provided in program information region 412. Region 412 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g. FTP).

Grid 402 may provide listings for non-linear programming including on-demand listing 414, recorded media listing 416, and Internet content listing 418. A display combining listings for content from different types of media sources is sometimes referred to as a “mixed-media” display. The various permutations of the types of listings that may be displayed that are different than display 400 may be based on user selection or guidance application definition (e.g., a display of only recorded and broadcast listings, only on-demand and broadcast listings, etc.). As illustrated, listings 414, 416, and 418 are shown as spanning the entire time block displayed in grid 402 to indicate that selection of these listings may provide access to a display dedicated to on-demand listings, recorded listings, or Internet listings, respectively. In other embodiments, listings for these media types may be included directly in grid 402. Additional listings may be displayed in response to the user selecting one of the navigational icons 420. (Pressing an arrow key on a user input device may affect the display in a similar manner as selecting navigational icons 420.)

Display 400 may also include video region 422, advertisement 424, and options region 426. Video region 422 may allow the user to view and/or preview programs that are currently available, will be available, or were available to the user. The content of video region 422 may correspond to, or be independent from, one of the listings displayed in grid 402. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 424 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 402. Advertisement 424 may also be for products or services related or unrelated to the media content displayed in grid 402. Advertisement 424 may be selectable and provide further information about media content, provide information about a product or a service, enable purchasing of media content, a product, or a service, provide media content relating to the advertisement, etc. Advertisement 424 may be targeted based on a user's profile/preferences, monitored user activity, the type of display provided, or on other suitable targeted advertisement bases.

While advertisement 424 is shown as rectangular or banner shaped, advertisements may be provided in any suitable size, shape, and location in a guidance application display. For example, advertisement 424 may be provided as a rectangular shape that is horizontally adjacent to grid 402. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. Patent Application Publication No. 2003/0110499, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 426 may allow the user to access different types of media content, media guidance application displays, and/or media guidance application features. Options region 426 may be part of display 400 (and other display screens of the present invention), or may be invoked by a user by selecting an on-screen option or pressing a dedicated or assignable button on a user input device. The selectable options within options region 426 may concern features related to program listings in grid 402 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

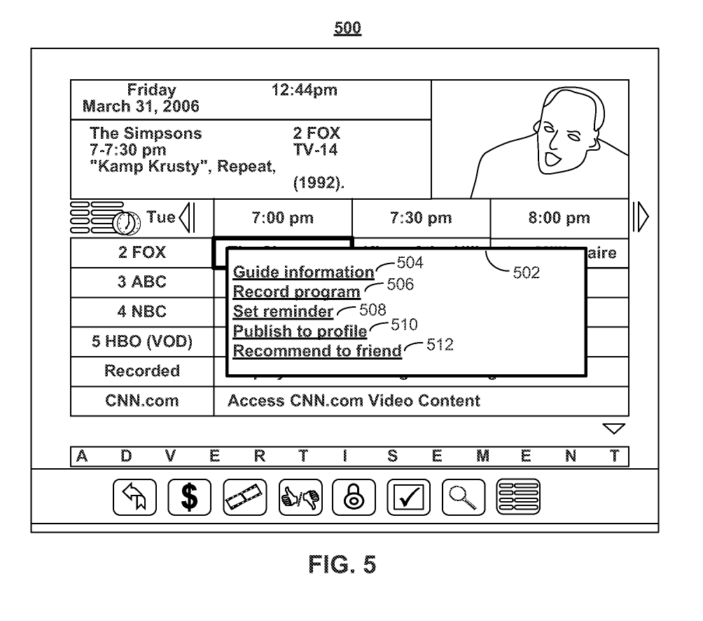

FIG. 5 shows a social media guidance application running inside interactive media guide 500. Processing circuitry (e.g., processing circuitry 206 in FIG. 2) may execute the application on a user equipment device (e.g., user equipment device 200 in FIG. 2). When the user selects a program from the guide, he may be presented a prompt (or dialog box) 502 with common guide options to view further Guide information 504, to Record program 506, and to Set reminder 508. In some embodiments, the user is further presented options, Publish to profile 510 and Recommend to friend 512. These options form a part of the social media guidance application, allowing the user to interact with one or more social networks. While watching a television program, the user may select option Publish to profile 510 to publish the program, his comments on the program, and his rating of the program, to his user profile on one or more social networks. In some embodiments, the user may recommend the program being currently viewed on the user equipment device, e.g., display 212 (FIG. 2). In some embodiments, the user may use user input interface 210 (FIG. 2) to pick a program listed in the interactive media guide for recommendation. In some embodiments, the social media guidance application may present the user with an array of media to choose from, including screenshots, video clips, audio clips, program episodes, and online links. Processing circuitry 206 (FIG. 2), under direction of the social media guidance application, may invoke a media locator (e.g., media locator 104 in FIG. 1) to search a social media content source (e.g., source 106 in FIG. 1) for related media.

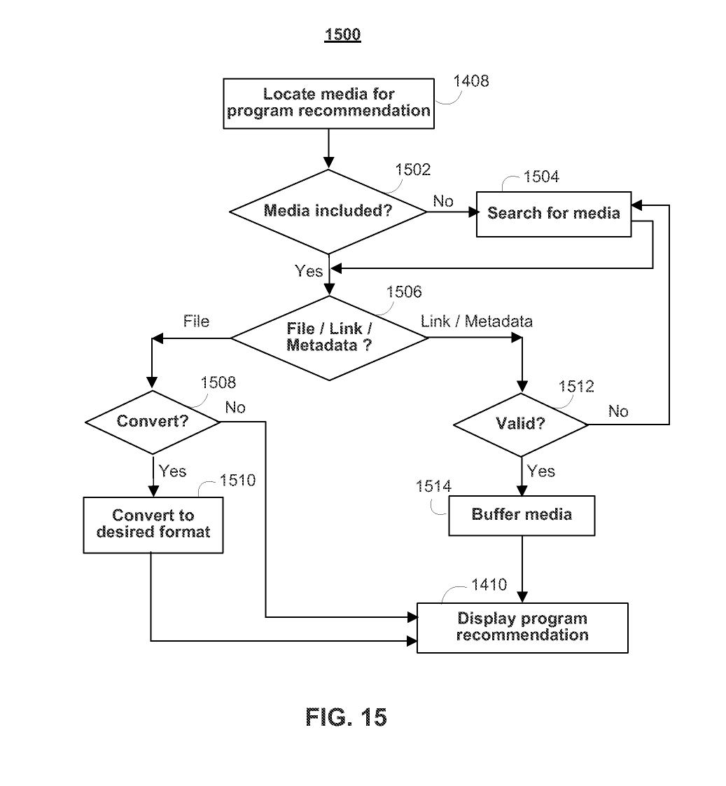

In some embodiments, the social media guidance application may direct processing circuitry 206 (FIG. 2) to automatically identify media to attach to the program recommendation, and prompt the user for comments and ratings for the program. In some embodiments, the media may be identified based on user-specified criteria, such as clip length or quality. In some embodiments, the media may be identified based on popularity, e.g., if the clip has been recommended by other users in the social network. Processing circuitry 206 (FIG. 2), under direction of the social media guidance application, may invoke a media locator (e.g., media locator 504 in FIG. 5) to search for related media in a social media content source (e.g., source 506 in FIG. 5). The media may include screenshots, video clips, audio clips, program episodes, online links, and other related media. Processing circuitry 206 (FIG. 2) may convert the media into a format readily playable on the target user equipment device. FIG. 15 presents in more detail an illustrative embodiment of operations for locating media for a program recommendation.

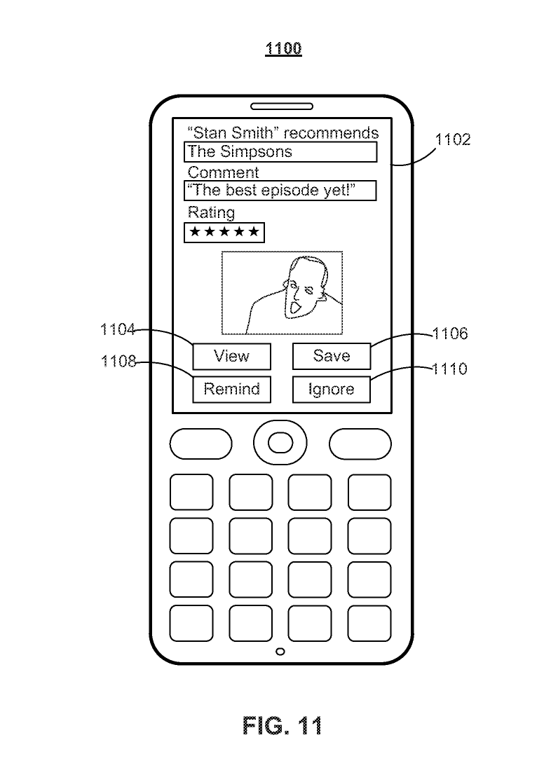

Instead of publishing to his profile, the user may want to share the program, comments, and ratings, with one or more users (or friends) only. The user may use user input interface 210 (FIG. 2) to select option Recommend to friend 512 in such a case. In some embodiments, the user may recommend a program to other users who are not on the user's friends list in the social network. For example, the user may send a recommendation to a user in another social network, or to users of other equipment devices (such as computers and mobile devices) that are not a part of the social network. In some embodiments, the user may specify an email address as the receiver and send a program recommendation as an email, which may be displayed on a computer or mobile device. In some embodiments, the user may specify a mobile phone number as the receiver and send a program recommendation as a text message. FIG. 11 shows an illustrative embodiment of a mobile device receiving such a program recommendation.

In some embodiments, the user may not publish or send any recommendations, but mark their comments and ratings for programs they like in a private metadata set. The private metadata set may be limited to information from one or more users of the social network, and may be stored, for example, in social media data source 508. Authorized users may then query the user's recommendations via the private metadata set, and receive program recommendations in this manner. In some embodiments, user comments and ratings may be accessible in a community metadata set stored, for example, in social media data source 508. The community metadata set may encompass viewing habits and program recommendations for all users of the social network. A user may query the social media guidance application for programs that users in his social network are watching. The application may aggregate users by program, and rank them based on number of users watching. This type of sharing is done in a “pull” fashion. This means that instead of passively receiving recommendations from other users, the user actively queries, for example, the community metadata set, for information on what users are watching. The user may then use this information as recommendations on programs to watch. For example, a query may produce a list of the five most popular programs being watched by users in his social network. In another example, a query may produce the five most watched programs for a certain user.

The media guidance application may allow a user to provide user profile information via user input interface 210 (FIG. 2), or may instruct processing circuitry 206 (FIG. 2) to automatically compile user profile information. The user profile may be integrated with or augmented by the user's social network profile. The media guidance application may, for example, monitor the media the user accesses and/or other interactions the user may have with the guidance application. The social application may instruct processing circuitry 206 (FIG. 2) to automatically publish recommendations to a user's profile based on such information. For example, if a user watches a television program for greater than a determined period of time, the social media guidance application may prompt the user for comments and ratings on the program, and then publish a recommendation to the user's social network profile. The social media guidance application may wait till the end of the program before prompting the user, or present a prompt the next time the user turns on the user equipment device.

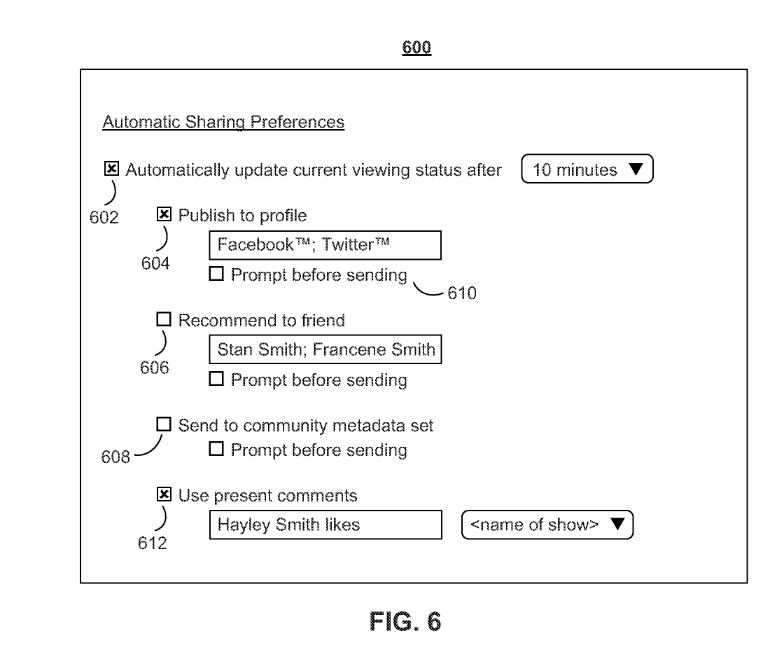

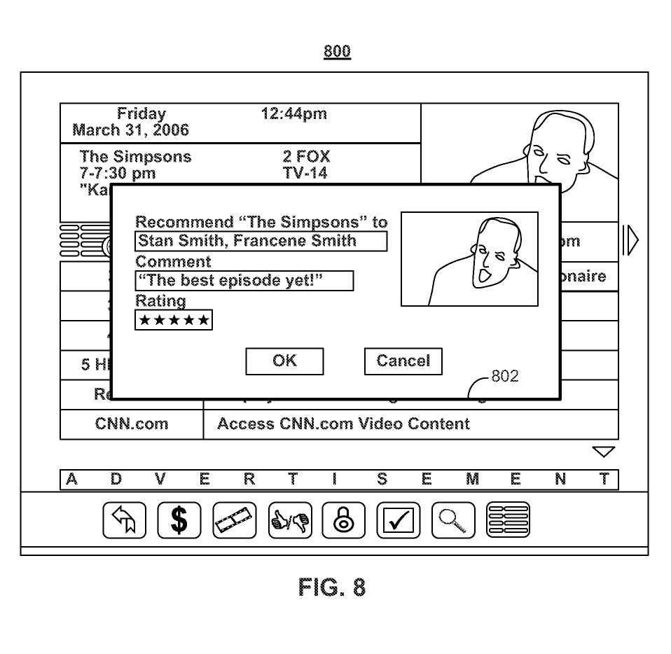

The social media guidance application may aid the user in making recommendations by automatically posting program recommendations to his profile. FIG. 6 shows illustrative sharing preferences screen 600 for a social media guidance application. The application may monitor the user's viewing activity and instruct processing circuitry 206 (FIG. 2) to automatically update the user's social network. For example, if box 602 is selected, the application may publish a recommendation for the program the user is currently watching after a predetermined period of time. For example, if the user is switching channels and eventually decides to watch a certain program, the application may publish a recommendation for the program after the user has been watching for at least 10 minutes. If the user switches channels before 10 minutes have elapsed, the application may not proceed with a recommendation. The user may set a lower or higher time threshold (option 554). The viewing activity may include program name, channel, air time, other guide information, user comments, and user rating. The user may further choose between publishing the viewing activity to one or more social networks (option 604), recommending the program to one or more friends (option 606), sending the information to a community metadata set (option 608), or any combination thereof. If box 610 is selected, the application prompts the user on display 212 (FIG. 2) for confirmation before sending any information. The application may further prompt the user for his comments and rating on the program being recommended (for example, as shown in FIG. 8). In some embodiments, the user may use user input interface 210 (FIG. 2) to choose media to attach to the recommendation. In some embodiments, the application may instruct processing circuitry 206 (FIG. 2) to automatically choose media for the program recommendation, as described above. In some embodiments, the application may allow the user to cancel a recommendation. The user may specify preset comments (option 612) in sharing preferences screen 600 to be inserted in the program recommendation.

Additionally, the social media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. Similarly, the social media guidance application may obtain all social network profiles related to the user, and integrate this information with information obtained from the media guidance profiles. As a result, a user may be provided with a unified guidance experience across the user's different devices.

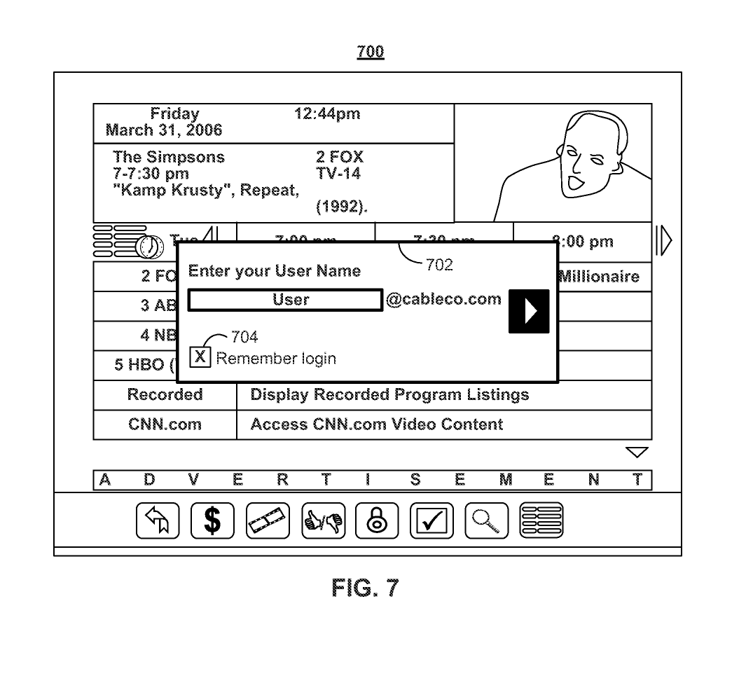

FIG. 7 shows login prompt 702 for the user to login to his social network. In some embodiments, the login may require a username and a password. The authentication process helps prevent unauthorized access to the user's social network profile. In some embodiments, the user enters login information via user input interface 210 (FIG. 2) for each social network where the user wants to publish the program recommendation. In some embodiments, a single login is linked to a plurality of social networks. For example, logging in to a “cableco.com” account shown in FIG. 7 may allow access to the user's Facebook™, MySpace™, and Twitter™ profiles. The linking process may be accomplished through the social media guidance application, through a webpage on the Internet, or automatically based on the login information entered by the user. In some embodiments, the user may be given the option to save the login information for future access via check box 704.

FIG. 8 shows an illustrative example of a user screen of a social media guidance application, where the user sends a recommendation to other users of his social network. In some embodiments, the user selects an option to recommend a program to a friend (e.g., option 512 in FIG. 5). The user is then presented prompt (or dialog box) 802 on display 212 (FIG. 2), where the user may specify one or more friends to send the recommendation, his comments on the program, and his rating of the program. In embodiments where the user is not required to or does not input any comments or ratings, the recommendation may use a predefined description of the program (e.g., extracted from the guide information) instead. In some embodiments, the recommendation includes a screenshot of the program. The application may instruct processing circuitry 206 (FIG. 2) to take a screenshot of the program at the current moment in time, or retrieve a screenshot from a remote media source or local storage 208 (FIG. 2). In some embodiments, the application may only be allowed to retrieve screenshots from an approved source due to digital rights restrictions. For example, a television channel may have preset screenshots stored on a remote server for each episode of a program. In some embodiments, the social application includes media in the recommendation, for example, an episode, an audio or video clip, or an advertisement for the program. The media may be sent as a file along with the recommendation, or as a link to the media on as remote server or the Internet. For example, the media may be a link to a clip related to the program posted on a streaming video website, for example, Youtube™ or Hulu™. In some embodiments, the user may specify the media using user input interface 210 (FIG. 2). The user may solicit the social media guidance application's aid by making a choice from a presented media list. The application may invoke a media locator (e.g., media locator 104 in FIG. 1) to identify the media list from a social media content source (e.g., social media content source 106 in FIG. 1). In some embodiments, the social media guidance application may instruct processing circuitry 206 (FIG. 2)to choose media for the program recommendation. An illustrative embodiment of operations for locating media automatically is discussed in FIG. 15. The user may select receivers of the recommendation using, for example, user input interface 210 (FIG. 2). The user may choose from a drop-down menu or input receivers through an on-screen keyboard. The social media guidance application then sends the requested program recommendation to the specified users. In some embodiments, the recommendation includes guide information for the program, e.g., airing date and time.

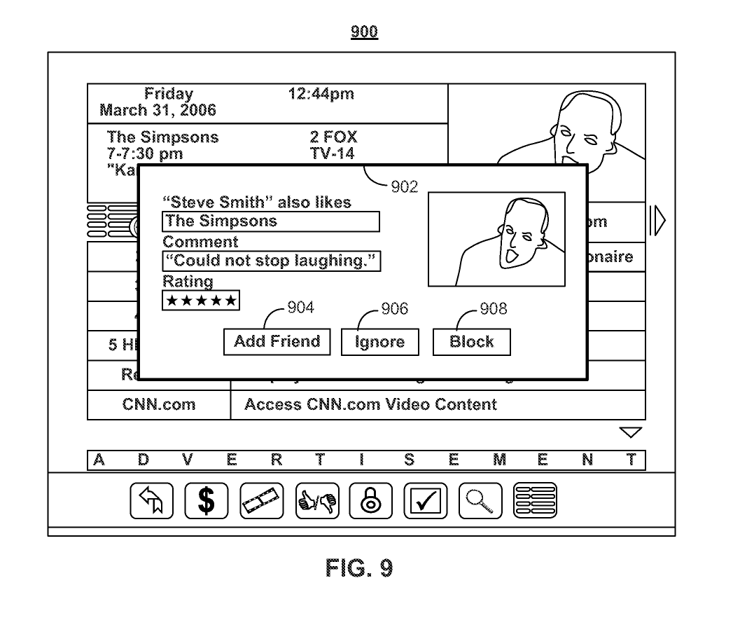

FIG. 9 shows an illustrative example of a user receiving recommendation 902 to add another user to their social network (or friend list). The criteria for suggesting a friend may be based on similarity in program recommendations and ratings, frequency of recommendations, types of programs recommended, and other related factors. The application may obtain such information from a community metadata set (e.g., stored in social media data source 108 in FIG. 1). For example, after a user publishes a recommendation for the television program, “The Simpsons”, the social media guidance application may suggest the user add another user who also recommends “The Simpsons”. The user may have the option to either add the suggested user as a friend (option 904), or ignore the suggestion (option 906). In some embodiments, only friends may be allowed to send recommendations to the user. In some embodiments, the user may block recommendations to add a particular user as a friend in the future (option 908).

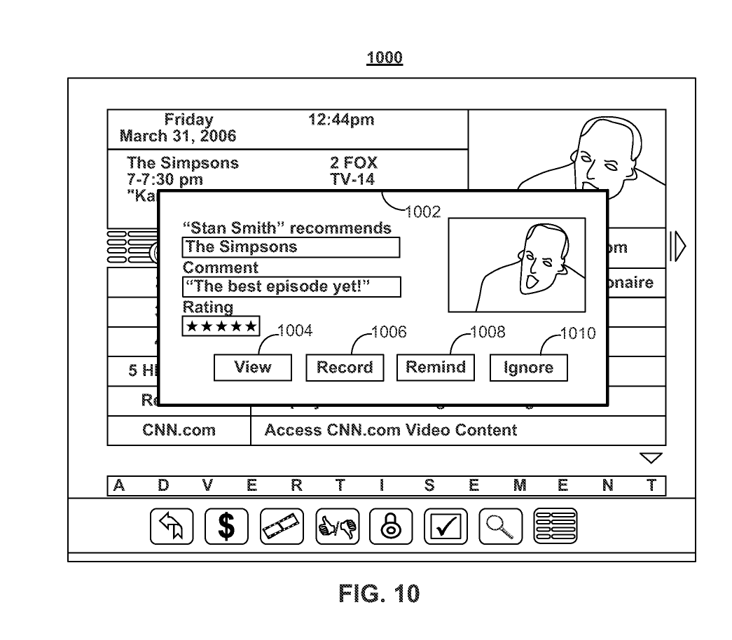

FIG. 10 shows an illustrative example of a user screen of the social media guidance application, where the user receives a program recommendation from another user of the social network. Another user of the social network may send a recommendation to the user with media, comments, and ratings to the user. For example, the user receives a recommendation 1002 for “The Simpsons” from user “Stan Smith”, including his comments and rating. The user may choose between viewing (option 1004), recording the next or all airings (option 1006), setting a reminder for the next or all airings (option 1008), and ignoring the recommendation (option 1010). The user may receive the recommendation immediately, the next time the application is triggered, after the current program being viewed ends, or during a commercial.

In some embodiments, the social media guidance application identifies and determines media to associate with the recommended program. Processing circuitry 206 (FIG. 2), under direction of the application, may invoke a media locator (e.g., media locator 104 in FIG. 1) to identify media from a social media content source (e.g., social media content source 106 in FIG. 1). For example, if the received media is corrupted, the received link is broken, or no media is received, the social media guidance application may attempt to find other media related to the program recommendation in the social media content source (e.g., social media content source 106 in FIG. 1). In another example, if the received media is a clip of a program, the social media guidance application may attempt to retrieve the entire episode or identify a local copy in storage 208 (FIG. 2) on the user equipment device. An illustrative embodiment of operations for locating media is presented in FIG. 15.

In some embodiments, another user sending the recommendation may be required to be in the user's social network (or friend list). In some embodiments, the social media guidance application may suppress program recommendations already received in the past. This may include repeat recommendations from the same user, or from different users. The user may have the option to view the media attached to the recommendation on display 212 (FIG. 2), to save the media for later viewing, to record the next airing of the program to storage 208 (FIG. 2), or to ignore the program recommendation. In some embodiments, the social media guidance application may block the other user from the user's social network, for example, if the program recommendations are too frequent or obscene in nature. In some embodiments, the user may have an option to set a reminder for the next airing of the program based on guide information included in the program recommendation.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a television. These devices also offer access to social networking applications, where users may share ideas, activities, events, and interests within their individual networks. Consequently, media guidance and sharing is necessary on these devices, as well. The guidance provided may be for media content available only through a television, for media content available only through one or more of these devices, or for media content available both through a television and one or more of these devices. Applications may be provided as online applications (i.e., provided on a web-site), or as stand-alone applications or clients on hand-held computers, PDAs, mobile telephones, or other mobile devices.

FIG. 11 shows an illustrative example of a mobile device receiving a program recommendation from a user of a social media guidance application. The mobile device may be an embodiment of user equipment device 200 of FIG. 2, or wireless user communications device 306 of FIG. 3. The recommendation may be received via email or text message to the mobile device. The recommendation may be presented immediately, or in response to a predetermined event. For example, the recommendation may be presented when the mobile device is switched from vibrate or silent mode to regular mode. This may avoid disturbing the mobile device user since the vibrate or silent mode may imply that, e.g., the user is in a meeting. In some embodiments, the recommendation may be forwarded to a user's mobile device if delivery fails to the user's equipment device. In some embodiments, the recommendation may be received by social media guidance application 1102 running on the mobile device. In some embodiments, clicking on a text message or email may trigger social media guidance application 1102. The mobile user may choose to view media attached to recommendation (option 1104), save for later viewing (option 1106), set a reminder on the mobile device for the next airing of the program (option 1108), or ignore the recommendation (option 1110). In some embodiments, the mobile device and the user equipment device may be linked via the social media guidance application. For example, on receiving the program recommendation, the user may set a recording for the next airing of the program. As a result, the social media guidance application on the mobile device may send instructions to the social media guidance application on the user equipment device to record the program.

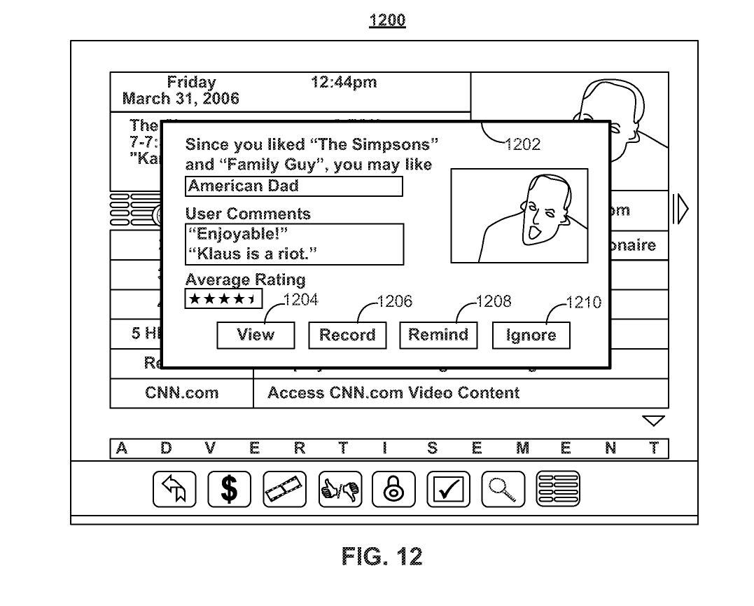

FIG. 12 shows an illustrative example of a user screen of the social media guidance application, where the user receives a program recommendation automatically from the social network. For example, after a user makes a program recommendation to another user of the social network, or publishes the recommendation to his profile, the social media guidance application may recommend another program to the user. For example, after the user posts program recommendation for “The Simpsons” and “Family Guy” to his profile, the social application may recommend program “American Dad” to the user (option 1202). The recommendation may be based on data from a community metadata set or be received from a sponsor of the “American Dad” program. Processing circuitry 206, under direction of the application, may invoke a media locator (e.g., media locator 104 in FIG. 1) to identify media for the recommendation from a social media content source (e.g., social media content source 106 in FIG. 1). Similar to FIG. 9, the user may choose between viewing (option 1204), recording the next or all airings (option 1206), setting a reminder for the next or all airings (option 1208), and ignoring the recommendation (option 1210). The user may receive the recommendation immediately, the next time the application is triggered, after the current program being viewed ends, or during a commercial. In some embodiments, the recommendation may be based on a community metadata set that contains recommendations, comments, and ratings from all users of the social network. The metadata set may form a part of social media data source 108 in FIG. 1. In some embodiments, the recommendation may be based on a community metadata set customized per user. The customized metadata set may include recommendations, comments, and ratings only from other users specified by the user, or from other users on the user's friend list.

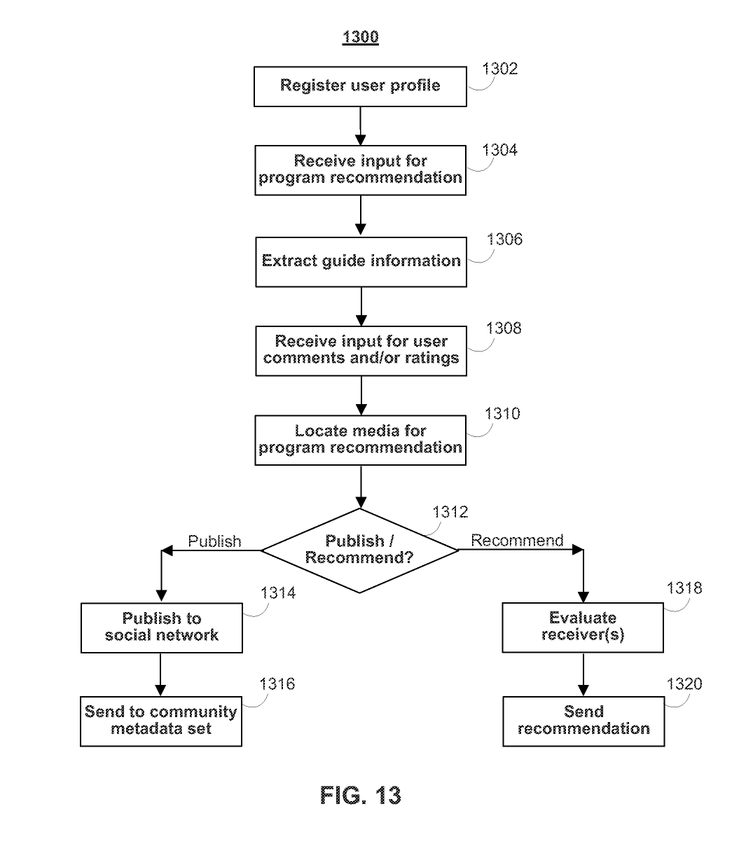

FIG. 13 shows illustrative flow diagram 1300 for transmitting recommendations via a social media guidance application. At 1302, if the social media guidance application is triggered, the user may register for a profile if none exists, or enter login information for an already existing profile via user input interface 210 (FIG. 2). The user may also choose to enter information for his profiles on multiple social networks. The login information may be saved to storage 208 (FIG. 2) for future access, without requiring the user to enter his information manually every time. At 1304, the user chooses a program for recommendation. For example, the user may choose to recommend the program currently being viewed on display 212 (FIG. 2), or choose a program from a listing in the interactive media guide. In some embodiments, the user may choose a program for recommendation indirectly as a result of certain behavior. For example, if a user watches more than one episode of the same program, the social media guidance application may instruct processing circuitry 206 (FIG. 2) to automatically publish a recommendation for the program to the user's profile. Similarly, if the user watches a particular program during prime time, where multiple programs are competing for viewership, the application may publish a program recommendation since the user chose the program over all other competing programs in the same timeslot. The application may store and obtain viewing habits from a social media data source (e.g., social media data source 108 in FIG. 1). The application may prompt the user for comments and ratings on display 212 (FIG. 2) before posting the recommendation, and may also provide the option to cancel the recommendation.

At 1306, the social media guidance application may extract guide information for the recommended program from, e.g., media guidance data source 318 (FIG. 3). At 1308, the social media guidance application may prompt the user for comments and ratings on the recommended program. At 1310, the social media guidance application may locate media to attach to the program recommendation. The media may be located on the user equipment device, a remote server, or the Internet. The application may invoke a media locator (e.g., media locator 104 in FIG. 1) to identify the media from a social media content source (e.g., social media content source 106 in FIG. 1). In some embodiments, the media includes an advertisement for the program. The media may be an audio or video clip of the program, or an entire episode, or metadata for a clip or an episode. In some embodiments, the clip or episode is extracted from a recording of the program on the user equipment device. In some embodiments, the clip may be associated with the program recommendation, but not extracted from a recording of the program on the user equipment device. For example, the clip may include a blooper reel to include in the program recommendation. The length of the clip may be input by the user, or determined by the social media guidance application. In some embodiments, the social media guidance application may identify media on the Internet to associate with the program. In some embodiments, the media includes metadata associated with a recording of the program on the user equipment device. The media may be a downloadable file, or a link to a file stored on a remote server or the Internet. An embodiment of operation 1310 is described in FIG. 15.

At 1312, the social media guidance application checks the user's sharing preferences (e.g., sharing preferences 600 in FIG. 6) to determine whether the user wishes the recommendation to be published to his profile, or to only be shared with a limited number of users of the social network. If the Publish to profile option is chosen, then at 1314, the social media guidance application may instruct processing circuitry 206 (FIG. 2) to publish the program recommendation to the user's profile on the social network. If the user has multiple social networks linked to the social media guidance application, the program recommendation may be published to all social networks specified by the user. At 1316, the information in the recommendation, for example, guide information, ratings, and comments, are sent to be included into a community metadata set. If the Recommend to friend option is chosen, then at 1318, the social media guidance application determines receivers of the program recommendation. Receiver information may be retrieved from a social media data source (e.g., social media data source 108 in FIG. 1) or sharing preferences (e.g., sharing preferences 600 in FIG. 6). The receivers may be other users of the social network specified by the user, or users of other social networks, or people not in any social network. In the last case, the program recommendation may be sent to the receiver via email, text message, or other media delivery methods. At 1320, the social media guidance application may send the program recommendation to the user-specified receivers.

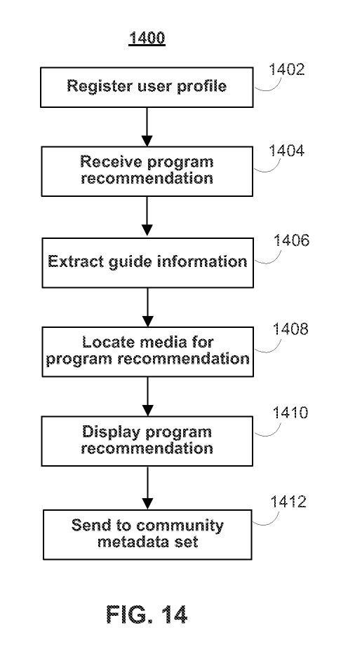

FIG. 14 shows illustrative flow diagram 1400 for receiving recommendations via a social media guidance application. At 1402, if the social media guidance application is triggered, the user may register for a profile if none exists, or enter login information for an already existing profile. The user may also choose to enter information for his profiles on multiple social networks. The login information may be saved for future access to, e.g., storage 208 (FIG. 2). The user may not be required to enter his information manually every time. At 1404, the user may receive a program recommendation. The program recommendation may include comments and ratings for the program. In some embodiments, the program recommendation may include guide information associated with the program. At 1406, the social media guidance application may extract guide information, e.g., air date and time, for the recommended program, if not already included. The information may be extracted from a media data source (e.g., social media data source 108 in FIG. 1 or media guidance data source 318 in FIG. 3). In some embodiments, the social media guidance application may need to convert the information for the user's circumstances. For example, the recommendation shown in FIG. 8 includes guide information that “The Simpsons” airs on Fridays from 7:00 pm to 7:30 pm on Channel 2. However, the user's local channel lineup may be different than that of the program recommendation. The social media application then determines that “The Simpsons” airs at 4:00 pm to 4:30 pm on Channel 5. In some embodiments, the program recommendation may include media associated with the program, for example, an episode, a clip, or an advertisement.

At 1408, the social media guidance application may locate media associated the recommended program. In some embodiments where a media file is included in the program recommendation, the social media guidance application may need to convert the media to a format viewable on the user equipment device. For example, if the user equipment device is a mobile device, the media file may need to be converted to a format readily playable on the mobile device. The mobile device may be an embodiment of user equipment device 102 in FIG. 1. The conversion may be performed on the user equipment device, or on a remote server. The remote server may convert the entire file before playback, or convert and stream media in real time to the user equipment device. In some embodiments, the social network application attempts to find other related media if the given media file is corrupted or not convertible for playback. If an Internet link to media is included in the program recommendation, the social media guidance application may download all or part of the media to the user equipment device before playback. In some embodiments, where the link may be broken, the social media guidance application may instruct processing circuitry 206 (FIG. 2) to search for the same or related media to present to the user. The application may invoke a media locator (e.g., media locator 104 in FIG. 1) to identify related from a social media content source (e.g., social media content source 106 in FIG. 1). An embodiment of operation 1408 is described in FIG. 15.

At 1410, the social media guidance application may present the recommendation, including guide information, comments, ratings, and related media to the user on display 212 (FIG. 2). The user may choose to view the media, save the media for later viewing, record the next airing of the program to, e.g., storage 208 (FIG. 2), set a reminder for the next airing of the program, or ignore the program recommendation. At 1412, the social media guidance application may send the program recommendation for inclusion in a community metadata set. The community metadata set may be a part of a social media data source (e.g., social media data source 108 in FIG. 1). For example, the user's acceptance of the recommendation may be recorded in the community metadata set. In embodiments where the recommendation is received via email, the recommendation may be added to the community metadata set to augment available information.

FIG. 15 shows an illustrative embodiment of operation 1310 (FIG. 13) or operation 1408 (FIG. 14) for identifying media to present as part of a program recommendation. The operations may be performed by a media locator (e.g., media locator 104 in FIG. 1), where the media locator may form a part of the social media guidance application. Media associated with a program recommendation may include a downloadable file, a link to a file on the Internet (or other networks), or metadata pointing to the relevant clip in a local or remote file. At 1502, the social media guidance application may determine if the program recommendation includes any type of media, for example, a file, a link, or metadata. If none found, at 1504, the application may search for media (related to the program) to present as part of the program recommendation. The application may use the guide information obtained at 1506 (FIG. 15) to search the user equipment device, social networks, remote servers, or the Internet. The application may perform a search when the recommendation is received, or when the user chooses to view the program recommendation. The application may invoke a media locator (e.g., media locator 104 in FIG. 1) to identify related from a social media content source (e.g., social media content source 106 in FIG. 1). The application then proceeds to 1506, further described below.

If media is found in the program recommendation at 1502, then the application proceeds to 1506. At 1506, the application may check whether the included media is either a file, or one of a link or metadata. If the included media is a file, the application proceeds to 1508. At 1508, the application determines if the file is in the correct format for playback on the user equipment device. For example, if the user equipment device is a mobile phone, at 1510, the application may convert the file to a format appropriate for a mobile device. The conversion may be offline or in real-time. Once the conversion is complete, or if no conversion is required, at 1510, the application may present the program recommendation to the user on display 212 (FIG. 2).

If the application determines the included media to be a link or metadata at 1506, it moves to verify the validity of the link or metadata at 1512. A link may point to a streaming file or a file to be downloaded temporarily (for example, due to digital rights restrictions). In the case of a link, the validity check may involve ensuring whether the media the link points to is still available, or if the media is playable on the user equipment device. Metadata may point to a segment of a media file located on the user equipment device, another user's equipment device, a remote server, or the Internet. For example, the metadata may be used to extract a segment from a recording on another user's equipment device in a peer-to-peer manner, without any intermediary servers. In the case of metadata, the validity check may involve ensuring the media file the metadata indexes to is available either on the user equipment device (e.g., in storage 208 in FIG. 2) or remotely. If the media (link or metadata) is found to be invalid, the application proceeds to 1504. At 1504, the application may search for media to associate with the program recommendation, as described above.

If the media (link or metadata) is verified to be valid, the application proceeds to 1514. At 1514, the application may instruct processing circuitry 206 (FIG. 2) to buffer a few seconds of the media file, or download the entire file, depending on operations allowed on the file. For example, in the case of metadata, the application may extract the segment the metadata points to, and download it to the user equipment device (e.g., storage 208 in FIG. 2) for playback. In another example, in the case of a link, the application may buffer a few seconds of a streaming file pointed to by the link, to allow for smooth playback. If allowed, the application may download the entire media file temporarily for local playback. Once the media is ready, the application proceeds to 1510 (FIG. 15), where the program recommendation is presented to the user. Though this embodiment is present in the user equipment device receiving the recommendation, similar operations to identify media may be implemented on user equipment device transmitting the recommendation.

It will be appreciated that while the discussion of media content has focused on video content, the principles of media guidance can be applied to other types of media content, such as music, images, etc.

The foregoing is merely illustrative of the principles of the present invention, and various modifications can be made by those skilled in the art without departing from the scope and spirit of the invention. The above described embodiments of the present invention are presented for purposes of illustration and not of limitation, and the present invention is limited only by the claims which follow.

1. A method of receiving media content within a social network in an interactive media guidance application, the method comprising:
receiving a media recommendation from the at least one social network associated with a user profile via a user equipment device;
identifying media content associated with the received media recommendation;
locating the identified media content within the plurality of content sources accessible from a user equipment device connected to the social network; and
presenting the received media recommendation to the user, wherein the media recommendation is presented with the located media content.

2. The method of claim 1 further comprising:
aggregating published information into a community metadata set; and
receiving the media recommendation automatically based on the community metadata set.

3. The method of claim 1, wherein identifying media content associated with the received media recommendation comprises validating media content received with the media recommendation.

4. The method of claim 1, wherein identifying media content associated with the received media recommendation comprises searching for media content to match the media recommendation.

5. The method of claim 1, wherein the located media content comprises a clip extracted from a media asset on a second user equipment device, and wherein identifying media content associated with the received media recommendation comprises identifying the clip for playback.

6. The method of claim 1, wherein the media content comprises metadata markers to a media asset on the user equipment device, the method further comprising:
allowing the user to view the media content on the user equipment device using metadata markers and a copy of the media asset on the user equipment device.

7. The method of claim 1, further comprising suppressing duplicates of media recommendations that have been made in the past.

8. The method of claim 1, further comprising recommending to the user one or more friends to add to the at least one social network based on their media recommendations.

9. The method of claim 1, wherein locating the identified media content further comprises converting the media content to a format playable on the user equipment device.

10. The method of claim 1 wherein locating the identified media content comprises allowing the user equipment device access to the located media content, and choosing between media content received with the media recommendation and the located media content.

11. A system for receiving media content within a social network in an interactive media guidance application on a user equipment device, the system comprising a storage device, a display device, and control circuitry, the control circuitry configured to:
receive a media recommendation from the at least one social network associated with a user profile via the user equipment device;
identify media content associated with the received media recommendation;
locate the identified media content within the plurality of content sources accessible from a user equipment device connected to the social network; and
present the received media recommendation to the user, wherein the media recommendation is presented with the located media content.

12. The system of claim 11, further configured to:
aggregate published information into a community metadata set; and
receive the media recommendation automatically based on the community metadata set.

13. The system of claim 11, wherein identifying media content associated with the received media recommendation comprises validating media content received with the media recommendation.

14. The system of claim 11, wherein identifying media content associated with the received media recommendation comprises searching for media content to match the media recommendation.

15. The system of claim 11, wherein the located media content comprises a clip extracted from a media asset on a second user equipment device, and wherein identifying media content associated with the received media recommendation comprises identifying the clip for playback.

16. The system of claim 11, wherein the media content comprises metadata markers to a media asset on the user equipment device, the system further configured to:
allow the user to view the media content on the user equipment device using metadata markers and a copy of the media asset on the user equipment device.

17. The system of claim 11, further configured to suppress duplicates of media recommendations that have been made in the past.

18. The system of claim 11, further configured to recommend to the user one or more friends to add to the at least one social network based on their media recommendations.

19. The system of claim 11, wherein locating the identified media content further comprises converting the media content to a format playable on the user equipment device.

20. The system of claim 11 wherein locating the identified media content comprises allowing the user equipment device access to the located media content, and choosing between media content received with the media recommendation and the located media content.

21-30. (canceled)
